(19) United States
(12) Patent Application Publication
(10) Pub. No.: US 2015/0376475 A1
(43) Pub. Date: Dec. 31, 2015

(54) POLYMER COMPOSITION, ADHESIVE COMPOSITION, TEMPERATURE-RESPONSIVE SHEET PRODUCED USING SAID POLYMER COMPOSITION, AND COLD-RELEASE ADHESIVE SHEET PRODUCED USING SAID ADHESIVE COMPOSITION

(71) Applicant: NITTO DENKO CORPORATION, Osaka (JP)

(72) Inventors: Asami Doi, Osaka (JP); Atsushi Takashima, Osaka (JP)

(21) Appl. No.: 14/843,851

(22) Filed: Sep. 2, 2015

Related U.S. Application Data
(63) Continuation of application No. 14/124,642, filed on Dec. 6, 2013.

(30) Foreign Application Priority Data
Jun. 13, 2011 (JP) 2011-131148
Jan. 20, 2012 (JP) 2012-010095
May 8, 2012 (JP) 2012-106814

(51) Int. Cl. C09J 133/10; C09J 133/08

(52) U.S. Cl. CPC C09J 133/10; C09J 133/08

(57) ABSTRACT

The purpose of the present invention is to provide a polymer composition which enables the steady and easy production of a temperature-responsive sheet. Provided is a polymer composition comprising a water-dispersible side-chain crystalline polymer and a water-dispersible amorphous polymer.

### TECHNICAL FIELD

The present invention relates to a polymer composition, an adhesive composition, a temperature-responsive sheet produced using the polymer composition, and a cold-release adhesive sheet produced using the adhesive composition.

### BACKGROUND ART

Conventionally, an adhesive sheet exists that exhibits non-adherability when the temperature is decreased below a prescribed temperature (refer to Patent Documents 1 to 4 for example).

A temperature-sensitive adhesive composition is disclosed in Patent Document 1 having 40 to 100% by weight of a side-chain crystalline polymer, which almost exhibits non-adherability at a temperature lower than a melting start temperature T₀ and exhibits adherability when it is heated from a temperature lower than T₀ to a temperature higher than a peak melting temperature Tₘ. The side-chain crystalline polymer of Patent Document 1 contains (a) a crystalline repeating unit which is derived from an acrylate or methacrylate ester, in which the ester group has the formula —COOR¹ wherein R¹ is a n-alkyl group having 14 to 22 carbon atoms; and (b) a repeating unit which is derived from an acrylate or methacrylate ester, in which the ester group has the formula —COOR² wherein R² is an amorphous straight chain or branched chain alkyl group having 1 to 9 carbon atoms or an amorphous branched chain alkyl group having 10 carbon atoms.

A temporary tacking adhesive tape for the step of laminating a laminate ceramic capacitor is disclosed in Patent Document 2 in which an adhesive layer is provided on one surface or both surfaces of a base film, and is characterized in that the adhesive layer contains a polymer composition containing a side-chain crystallizable polymer composed of a copolymer of 60 to 90 parts by weight of stearylacrylate, 10 to 30 parts by weight of methylacrylate, and 2 to 10% by weight of acrylic acid;

and in that, the polymer has first-order melting transition that occurs over a temperature range narrower than 15° C. Further, Patent Document 2 describes that the side-chain crystallizable polymer exists in an amount that is sufficient for the adhesive layer constituted from the polymer composition to exhibit almost non-adherability at a temperature equal to or lower than room temperature and adherability at a temperature higher than room temperature.

An adhesive tape for temporary attachment of green sheets for a ceramic electronic component is disclosed in Patent Document 3 in which an adhesive layer is provided on one surface or both surfaces of a base film, and is characterized in that the adhesive layer contains an adhesive composition containing, as a constituent, an acrylic acid ester and/or methacrylic acid ester with a straight chain alkyl group having 16 or more carbon atoms as a side chain and a side-chain crystallizable polymer having first-order melting transition that occurs over a temperature range narrower than about 35° C.; and in that the adhesive layer has a modulus of elasticity of 5×10⁴ Pa to 1×10⁸ Pa. Further, Patent Document 3 discloses that the side-chain crystallizable polymer is obtained from a monomer mixture of an acrylic acid ester having 16 or more carbon atoms, an acrylic acid ester having 1 to 6 carbon atoms, and a carboxy group-containing ethylenically unsaturated monomer.

Furthermore, Patent Document 3 describes that the side-chain crystallizable polymer exists in an amount that is sufficient for the adhesive layer constituted from the adhesive composition to exhibit almost non-adherability at a temperature equal to or lower than a set temperature and adherability at a temperature higher than the set temperature.

A method for producing an aqueous latex polymer composition is disclosed in Patent Document 4 comprising the steps of (a) mixing a first mixture (monomers in this mixture are water-insoluble) containing (1) at least one type of along chain alkylacrylate monomer having 12 to 24 carbon atoms in the alkyl group, (2) water and (3) an emulsifier; (b) homogenizing the first mixture to form an emulsion; (c) starting radical polymerization of the homogenized first mixture using a catalytically effective amount of an initiator; and (d) adding to the first mixture a water-soluble second mixture of a short alkyl chain monomer containing an alkyl group having less than 12 carbon atoms. Further, Patent Document 4 describes that the alkyl chain of the long chain alkylacrylate monomer is not crystallized at room temperature and peeling characteristics are not imparted when the monomer has less than 12 carbon atoms.

### PRIOR ART DOCUMENTS

### Patent Documents

Patent Document 1: JP-A-2002-322448

Patent Document 2: Japanese Patent 3485412

Patent Document 3: JP-A-2000-351951

Patent Document 4: Japanese Patent 3638957

### SUMMARY OF THE INVENTION

### Problems to be Solved by the Invention

A side-chain crystalline monomer and an amorphous monomer are mixed at the stage of monomer, and the monomer mixture is then polymerized to obtain a copolymer of any of the adhesives disclosed in Patent Documents 1 to 3. In Patent Document 4, two-step polymerization is used in order to form a copolymer. However, there is a problem that it is difficult to produce stably a copolymer of the side-chain crystalline monomer having high hydrophobicity and the amorphous polymer having high hydrophilicity as described above.

### Means for Solving the Problems

The present inventors have investigated a polymer composition in order to solve the above-described conventional problems. As a result, they have found that when a sheet is formed using a polymer composition containing a water-dispersible side-chain crystalline polymer and a water-dispersible amorphous polymer, a temperature-responsive sheet is produced stably and simply, and this finding has led to the completion of the present invention.

That is, a polymer composition according to the present invention comprises a water-dispersible side-chain crystalline polymer and a water-dispersible amorphous polymer.

The adhesive composition according to the present invention comprises the polymer composition.

The water-dispersible side-chain crystalline polymer and the water-dispersible amorphous polymer are separately polymerized in advance and mixed together to obtain the polymer composition and the adhesive composition. Therefore, the polymer composition and adhesive composition according to the present invention can be produced stably and simply. When the polymer composition is used to produce a sheet, a temperature-responsive sheet can be produced in which the physical properties such as adherability, water repellency, flexibility, transparency, thermal conductivity, electrical conductivity, and releasing of drugs can be varied depending on the temperature. When the adhesive composition is used to produce a sheet, a cold-release adhesive sheet can be produced. Therefore, a cold-release adhesive sheet can be produced stably and simply with the adhesive composition of the present invention. Because two types of the water-dispersible polymers are blended together in the polymer composition, a crystalline phase and an amorphous phase can be separated clearly. As a result, when the polymer composition is used, a temperature-responsive sheet having sharp temperature sensitivity can be obtained. In addition, the cost can be relatively easily reduced because the polymer composition and the adhesive composition are water-based compositions.

In the configuration, the water-dispersible amorphous polymer preferably has a glass transition temperature equal to or lower than the glass transition temperature of the water-dispersible side-chain crystalline polymer. When the water-dispersible amorphous polymer has a glass transition temperature equal to or lower than the glass transition temperature of the water-dispersible side-chain crystalline polymer, a sheet comprised of a single layer and having a good film forming property can be easily obtained at a relatively low temperature. When the water-dispersible amorphous polymer has a glass transition temperature equal to or lower than the glass transition temperature of the water-dispersible side-chain crystalline polymer, embrittlement of the temperature-responsive sheet to be produced is suppressed.

A temperature-responsive sheet according to the present invention is produced using the polymer composition.

A cold-release adhesive sheet according to the present invention is produced using the adhesive composition.

The water-dispersible side-chain crystalline polymer and the water-dispersible amorphous polymer are separately polymerized in advance and mixed together to obtain the polymer composition and the adhesive composition. Therefore, the polymer composition and the adhesive composition can be produced stably and simply. When the polymer composition is used to produce a sheet, a temperature-responsive sheet can be produced in which the physical properties such as adherability, water repellency, flexibility, transparency, thermal conductivity, electrical conductivity, and releasing of drugs can be varied depending on the temperature. When the adhesive composition is used to produce a sheet-shaped product, the sheet-shaped product can be formed into a cold-release adhesive sheet. Therefore, the temperature-responsive sheet of the present invention is produced stably and simply by using the polymer composition. Further, the cold-release adhesive sheet of the present invention is produced stably and simply by using the adhesive composition. In addition, the cost can be relatively easily reduced because the polymer composition and the adhesive composition are water-based compositions. Because the cold-release adhesive sheet of the present invention contains a water-dispersible side-chain crystalline polymer, transition between adhesiveness and non-adhesiveness of the sheet can be possible depending on the temperature, and because it contains a water-dispersible amorphous polymer, the adhesive strength can be controlled. Because two types of the water-dispersible polymers are blended together in the temperature-responsive sheet and the cold-release adhesive sheet, a crystalline phase and an amorphous phase can be separated clearly, and a cold-release tape can be obtained having sharp temperature sensitivity.

### Effect of the Invention

According to the polymer composition of the present invention, a temperature-responsive sheet can be produced stably and simply.

### MODE FOR CARRYING OUT THE INVENTION

The polymer composition of the present invention is a polymer composition containing a water-dispersible side-chain crystalline polymer and a water-dispersible amorphous polymer. First, the water-dispersible side-chain crystalline polymer and the water-dispersible amorphous polymer will be described below.

(Water-Dispersible Side-Chain Crystalline Polymer)

The water-dispersible side-chain crystalline polymer is not especially limited as long as it is a polymer in which the side chain is orientated and it is crystallized at a temperature equal to or lower than the melting point. However, examples thereof may include polymers in which a (meth)acrylate having —COOR¹ is used as a monomer component. Example of R¹ may include straight chain and branched chain alkyl groups having 10 to 40 carbon atoms. The melting point refers to a peak melting temperature Tₘ that is measured at a heating rate of 5° C./minute with a differential scanning calorimeter (DSC). The water-dispersible side-chain crystalline polymer preferably has a melting point in a range of −30 to 110° C., and more preferably in a range of −10 to 90° C.

The water-dispersible side-chain crystalline polymer may contain a unit corresponding to other monomer components that are copolymerizable with the monomer components, if necessary. Examples of the monomer components include functional group-containing vinyl monomers of carboxyl group-containing monomers such as acrylic acid, methacrylic acid, fumaric acid, maleic acid, crotonic acid, and carboxyethyl(meth)acrylate; carboxylic acid vinyl esters such as vinyl acetate and vinyl propionate; hydroxyl group-containing vinyl monomers such as 2-hydroxyethyl acrylate, 2-hydroxypropyl acrylate, and 2-hydroxybutyl acrylate; amide group-containing unsaturated monomers such as (meth)acrylamide, N,N-dimethyl(meth)acrylamide, N,N-diethyl(meth)acrylamide, N-isopropyl(meth)acrylamide, N-butyl(meth)acrylamide, N-methoxymethyl(meth)acrylamide, N-methylol(meth)acrylamide, N-methylolpropane(meth)acrylamide, and N-vinylcarboxylic amide; amino group-containing unsaturated monomers such as aminoethyl(meth)acrylate, N,N-dimethylaminoethyl(meth)acrylate, and t-butylaminoethyl(meth)acrylate; glycidyl group-containing unsaturated monomers such as glycidyl(meth)acrylate and methylglycidyl(meth)acrylate; cyano group-containing unsaturated monomers such as acrylonitrile and methacrylonitrile; isocyanate group-containing unsaturated monomers such as 2-methacryloyloxyethylisocyanate; sulfonic acid group-containing unsaturated monomers such as styrenesulfonic acid, allylsulfonic acid, 2-(meth)acrylamide-2-methylpropane sulfonic acid, (meth)acrylamidepropane sulfonic acid, sulfopropyl(meth)acrylate, and (meth)acryloyloxynaphthalene sulfonic acid; maleimide-based monomers such as N-cyclohexylmaleimide, N-isopropylmaleimide, N-laurylmaleimide, and N-phenylmaleimide; itaconimide-based monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide-based monomers such as N-(meth)acryloyloxymethylene succinimide, N-(meth)acryloyl-6-oxyhexamethylene succinimide, and N-(meth)acryloyl-8-oxyoctamethylene succinimide; glycol-based acryl ester monomers such as polyethyleneglycol(meth)acylate, propyleneglycol(meth)acrylate, methoxyethyleneglycol(meth)acrylate, and methoxypolypropyleneglycol(meth)acrylate; and the like.

Examples of the functional group-containing vinyl monomer include multifunctional monomers. Examples of the multifunctional monomer include (mono or poly) alkylene glycol di(meth)acrylates such as (mono or poly) ethyleneglycol di(meth)acrylates of ethyleneglycol di(meth)acrylate, diethyleneglycol di(meth)acrylate, triethyleneglycol di(meth)acrylate, trimethylolpropane tri(meth)acrylate, and tetraethyleneglycol di(meth)acrylate; and (mono or poly) propyleneglycol di(meth)acrylate of propyleneglycol di(meth)acrylate; (meth)acrylate monomers of polyhydric alcohol such as neopentylglycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; divinylbenzene; and the like. Examples of the multifunctional monomer include epoxyacrylate, polyester acrylate, urethane acrylate, and the like.

Examples of the copolymerizable monomer include alkoxysilyl group-containing vinyl monomers. Examples of the alkoxysilyl group-containing monomer include silicone-based (meth)acrylate monomers and silicone-based vinyl monomers.

Examples of the silicone-based (meth)acrylate monomer include (meth)acyloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; (meth)acryloyloxyalkyl-dialkyl(mono)alkoxysilanes corresponding thereto; and the like.

Examples of the silicone-based vinyl monomer include vinyltrialkoxysilanes such as vinyltrimethoxysilane, vinyltriethoxysilane, vinyltripropoxysilane, vinyltriisopropoxysilane, and vinyltributoxysilane; vinylalkyldialkoxysilane and vinyldialkylalkoxysilane corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane; (vinylalkyl)alkyldialkoxysilane and (vinylalkyl)dialkyl(mono)alkoxysilane corresponding thereto; and the like.

Specific examples of the water-dispersible side-chain crystalline polymer include acylate, fluoroacrylate, methacrylate, and a vinylester polymer described in J. Poly. Sci. 10:3347 (1972), J. Poly. Sci. 10:1657 (1972), J. Poly. Sci. 9:3367 (1971), J. Poly. Sci. 9:3349 (1971), J. Poly. Sci. 9:1835 (1971), J.A.C.S. 76:6280 (1954), J. Poly. Sci. 7:3053 (1969), Polymer J. 17:991 (1985); corresponding acrylamide; substituted acrylamide; and a maleimide polymer (J. Poly. Sci.: Poly. Physics Ed. 18:2197 (1980)); poly(α-olefin) polymers such as those described in J. Poly. Sci.: Macromol. Rev. 8:117-253 (1974) and Macromolecules 13:12 (1980); polyalkylvinylethers such as those described in Macromolecules 13:15 (1980); polyalkylethyleneoxide; alkylphosphazene polymers such as those described in Poly. Sci. USSR 21:241 and Macromolecules 18:2141; polyamino acid; polyisocyanates such as those described in Macromolecules 12:94 (1979); polyurethane that is prepared by reacting amine or an alcohol-containing monomer with long chain alkylisocyanate, such as those described in Macromolecules 19:611 (1986); polyester and polyether; polysiloxane and polysilane; and p-alkylstyrene polymers such as those described in J. A. C. S. 75:3326 (1953) and J. Poly. Sci. 60:19 (1962).

(Water-Dispersible Amorphous Polymer)

The water-dispersible amorphous polymer is not especially limited as long as it is an amorphous polymer that does not have a melting point but only has a glass transition point, and examples thereof may include polymers in which a (meth)acrylic acid ester having —COOR² is used as a monomer component. Examples of R² may include straight chain and branched chain alkyl groups having 1 to 9 carbon atoms.

The water-dispersible amorphous polymer may contain a unit corresponding to other monomer components that are copolymerizable with the monomer components, if necessary. Examples of the monomer components include functional group-containing vinyl monomers of carboxyl group-containing monomers such as acrylic acid, methacrylic acid, fumaric acid, maleic acid, crotonic acid, and carboxyethyl(meth)acrylate; carboxylic acid vinyl esters such as vinyl acetate and vinyl propionate; hydroxyl group-containing vinyl monomers such as 2-hydroxyethyl acrylate, 2-hydroxypropyl acrylate, and 2-hydroxybutyl acrylate; amide group-containing unsaturated monomers such as (meth)acrylamide, N,N-dimethyl(meth)acrylamide, N,N-diethyl(meth)acrylamide, N-isopropyl(meth)acrylamide, N-butyl(meth)acrylamide, N-methoxymethyl(meth)acrylamide, N-methylol(meth)acrylamide, N-methylolpropane(meth)acrylamide, and N-vinylcarboxylic amide; amino group-containing unsaturated monomers such as aminoethyl(meth)acrylate, N,N-dimethylaminoethyl(meth)acrylate, and t-butylaminoethyl(meth)acrylate; glycidyl group-containing unsaturated monomers such as glycidyl(meth)acrylate and methylglycidyl(meth)acrylate; cyano group-containing unsaturated monomers such as acrylonitrile and methacrylonitrile; isocyanate group-containing unsaturated monomers such as 2-methacryloyloxyethylisocyanate; sulfonic acid group-containing unsaturated monomers such as styrenesulfonic acid, allylsulfonic acid, 2-(meth)acrylamide-2-methylpropane sulfonic acid, (meth)acrylamidepropane sulfonic acid, sulfopropyl(meth)acrylate, and (meth)acryloyloxynaphthalene sulfonic acid; maleimide-based monomers such as N-cyclohexylmaleimide, N-isopropylmaleimide, N-laurylmaleimide, and N-phenylmaleimide; itaconimide-based monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide-based monomers such as N-(meth)acryloyloxymethylene succinimide, N-(meth)acryloyl-6-oxyhexamethylene succinimide, and N-(meth)acryloyl-8-oxyoctamethylene succinimide; glycol-based acryl ester monomers such as polyethyleneglycol(meth)acylate, propyleneglycol(meth)acrylate, methoxyethyleneglycol(meth)acrylate, and methoxypolypropyleneglycol(meth)acrylate; and the like.

Examples of the functional group-containing vinyl monomer include multifunctional monomers. Examples of the multifunctional monomer include (mono or poly) alkylene glycol di(meth)acrylates such as (mono or poly) ethyleneglycol di(meth)acrylates of ethyleneglycol di(meth)acrylate, diethyleneglycol di(meth)acrylate, triethyleneglycol di(meth)acrylate, trimethylolpropane tri(meth)acrylate, and tetraethyleneglycol di(meth)acrylate; and (mono or poly) propyleneglycol di(meth)acrylate of propyleneglycol di(meth)acrylate; (meth)acrylate monomers of polyhydric alcohol such as neopentylglycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; divinylbenzene; and the like. Examples of the multifunctional monomer include epoxyacrylate, polyester acrylate, urethane acrylate, and the like.

Examples of the copolymerizable monomer include alkoxysilyl group-containing vinyl monomers. Examples of the alkoxysilyl group-containing monomer include silicone-based (meth)acrylate monomers and silicone-based vinyl monomers.

Examples of the silicone-based (meth)acrylate monomer include (meth)acyloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; (meth)acryloyloxyalkyl-dialkyl(mono)alkoxysilanes corresponding thereto; and the like.

Examples of the silicone-based vinyl monomer include vinyltrialkoxysilanes such as vinyltrimethoxysilane, vinyltriethoxysilane, vinyltripropoxysilane, vinyltriisopropoxysilane, and vinyltributoxysilane; vinylalkyldialkoxysilane and vinyldialkylalkoxysilane corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane; (vinylalkyl)alkyldialkoxysilane and (vinylalkyl)dialkyl(mono)alkoxysilane corresponding thereto; and the like.

The water-dispersible amorphous polymer preferably has a glass transition temperature (Tg) in a range of −200° C. to 110° C., and preferably in a range of −150° C. to 90° C.

The water-dispersible amorphous polymer preferably has a glass transition temperature equal to or lower than the glass transition temperature of the water-dispersible side-chain crystalline polymer. More preferably, the water-dispersible amorphous polymer has a glass transition temperature which is lower in a range of 0° C. to 180° C., and further preferably lower in a range of 5° C. to 150° C. as compared to the glass transition temperature of the water-dispersible side-chain crystalline polymer. When the water-dispersible amorphous polymer has a glass transition temperature equal to or lower than the glass transition temperature of the water-dispersible side-chain crystalline polymer, a sheet comprised of a single layer and having a good film forming property can be easily obtained at a relatively low temperature. The glass transition temperature (Tg) in the present invention refers to a value that is calculated using the following Fox's Formula. A value described in Polymer Handbook Third Edition (Wiley-Interscience) can be used as the glass transition temperature of each monomer in the Fox's Formula:

1/Tg=(W₁/Tg₁)+(W₂/Tg₂)+ . . . +(Wₘ/Tgₘ)

W₁+W₂+ . . . +Wₘ=1 <Fox's Formula>

wherein, Tg represents the glass transition temperature of a polymer, and each of Tg₁, Tg₂, . . . , and Tgₘ represents the glass transition temperature of each monomer. Each of W₁, W₂, . . . , and Wₘ represents the weight ratio of each monomer.

(Method for Producing Polymer Composition)

The water-dispersible side-chain crystalline polymer and the water-dispersible amorphous polymer are mixed together to produce the polymer composition. Each of the water-dispersible side-chain crystalline polymer and the water-dispersible amorphous polymer may be used alone or in combination of two or more types.

The water-dispersible side-chain crystalline polymer may be used as it is in the production of the polymer composition. However, an emulsion of the water-dispersible side-chain crystalline polymer may be used, or a solution may be used in which the water-dispersible side-chain crystalline polymer is dispersed.

A liquid phase of oil containing a monomer component for producing the water-dispersible side-chain crystalline polymer and an aqueous phase containing water and an emulsifier are prepared, these are mixed together and then emulsified by a homomixer, etc., to prepare a monomer pre-emulsion, and the monomer pre-emulsion is polymerized to obtain the emulsion of the water-dispersible side-chain crystalline polymer.

Examples of an emulsification apparatus that is used in the present invention include, but are not especially limited to, an ultrasonic homogenizer, TKHomomixer (manufactured by PRIMIX Corporation), TK Filmics (manufactured by PRIMIX Corporation), a high pressure homogenizer (PANDA 2K, manufactured by GEA Niro Soavi), Microfluidizer (manufactured by Microfluidics), Nanomizer (manufactured by Yoshida Kikai Co., Ltd.), and the like. As a polymerization method of the monomer pre-emulsion, general collective polymerization, continuous dropwise polymerization, divided dropwise polymerization, etc., can be adopted, and the polymerization temperature is about 20 to 100° C., for example. The oil phase liquid may contain an oil-soluble initiator and a hydrophobic compound as an arbitrary component, if necessary.

The water-dispersible amorphous polymer may be used as it is in the production of the polymer composition. However, an emulsion of the water-dispersible amorphous polymer may be used or a solution may be used in which the water-dispersible amorphous polymer is dispersed.

A liquid phase of oil containing a monomer component for producing the water-dispersible amorphous polymer and an aqueous phase containing water and an emulsifier are prepared, these are mixed together and then emulsified by a homomixer, etc., to prepare a monomer pre-emulsion, and the monomer pre-emulsion is polymerized to obtain the emulsion of the water-dispersible amorphous polymer. As a polymerization method of the monomer pre-emulsion, general collective polymerization, continuous dropwise polymerization, divided dropwise polymerization, etc., can be adopted, and the polymerization temperature is about 20 to 100° C., for example.

Other additives can be appropriately blended in the polymer composition, if necessary. Examples of the other additives include a crosslinking agent, a tackifier, a preservative, a pH adjusting agent, a chain-transfer agent, a filler, a pigment, a coloring agent, and the like. These additives may be used alone or in combination of two or more types.

A conventionally known crosslinking agent can be used as the crosslinking agent, and examples thereof include an isocyanate-based crosslinking agent, an epoxy-based crosslinking agent, an oxazoline-based crosslinking agent, an aziridine-based crosslinking agent, a metal chelate-based crosslinking agent, and the like. The crosslinking agent may be oil-soluble or water-soluble.

Examples of the tackifier may include those having a rosin-based resin, a terpene-based resin, an aliphatic petroleum resin, an aromatic petroleum resin, a copolymer-based petroleum resin, an alicyclic petroleum resin, a xylene resin, an elastomer, and the like as tackifier components.

(Polymer Composition)

As described above, the water-dispersible side-chain crystalline polymer and the water-dispersible amorphous polymer are polymerized separately, and these polymers are mixed together to obtain the polymer composition of the present invention. Therefore, the polymer composition according to the present invention can be produced stably and simply. When the polymer composition is used to produce a sheet-shaped product, a temperature-responsive sheet can be obtained. Therefore, a temperature-responsive sheet can be produced stably and simply with the polymer composition of the present invention. In addition, the cost can be reduced relatively easily because the polymer composition is water-based composition.

The content of the water-dispersible side-chain crystalline polymer that is contained in the polymer composition is preferably 1 to 99.9% by weight, and more preferably 10 to 90% by weight. The content of the water-dispersible amorphous polymer that is contained in the polymer composition is preferably 0.1 to 99% by weight, and more preferably 10 to 90% by weight.

In the case of an adhesive composition containing the polymer composition, the content of the water-dispersible side-chain crystalline polymer that is contained in the adhesive composition is preferably 5% by weight or more, and more preferably 10% by weight or more. The content of the water-dispersible amorphous polymer that is contained in the polymer composition is preferably 0% by weight or more, and more preferably 30% by weight or more. The content of the water-dispersible side-chain crystalline polymer and the content of the water-dispersible amorphous polymer are made to be in the above-described ranges so that an adhesive having good temperature sensitivity can be obtained.

(Temperature-Responsive Sheet)

The temperature-responsive sheet of the present invention has at least a temperature-responsive layer that is produced from the polymer composition. The properties of the temperature-responsive sheet can be changed with the temperature because it has the temperature-responsive layer. When the temperature-responsive sheet is especially used as a cold-release adhesive sheet, transition between adhesiveness and non-adhesiveness of the sheet can be possible depending on the temperature because of containing water-dispersible amorphous polymer, and the adhesive strength can be controlled because of containing water-dispersible amorphous polymer. Two types of the water-dispersible polymers are blended together in the cold-release adhesive sheet, and therefore a crystalline phase and an amorphous phase can be separated clearly, and a cold-release tape can be obtained having sharp temperature sensitivity.

The temperature-responsive sheet of the present invention may be composed of only a single layer of the temperature-responsive layer, or may have the temperature-responsive layer formed on a base. The temperature-responsive layer may be multiple layers.

The thickness of the temperature-responsive layer is not especially limited. However, it is preferably 1 to 100 μm, and more preferably 3 to 50 μm from the viewpoint of processability.

The base becomes a mother base for strength of the temperature-responsive sheet. Examples thereof include polyolefins such as low density polyethylene, straight-chain polyethylene, medium density polyethylene, high density polyethylene, ultra low density polyethylene, random copolymer polypropylene, block copolymer polypropylene, homopolypropylene, polybutene, and polymethylpentene; polyesters such as an ethylene-vinylacetate copolymer, an aionomer resin, an ethylene-(meth)acrylic acid copolymer, an ethylene-(meth)acrylate (random and alternating) copolymer, an ethylene-butene copolymer, an ethylene-hexene copolymer, polyurethane, polyethylene terephthalate, and polyethylene naphthalate; polycarbonate; polyimide; polyetheretherketone; polyimide; polyetherimide; polyamide; wholly aromatic polyamide; polyphenyl sulfide; aramid (paper); glass, a glass cloth; a fluororesin; polyvinyl chloride; polyvinylidene chloride; a cellulosic resin; a silicone resin; metal (foils); paper; and the like.

Examples of a material of the base include polymers such as a crosslinked body of the above-described resin. The plastic film may be used without being stretched or may be used after a monoaxial or biaxial stretching process is performed, if necessary.

The surface of the base can be subjected to traditional surface treatments such as chemical or physical treatments of a chromic acid treatment, ozone exposure, flame exposure, high voltage electric shock exposure, and an ionization irradiation treatment; and a coating treatment with a primer such as an adhesive substance described later. The same type or different type of materials can be selected and used as the base, and several types can be blended and used, if necessary.

The thickness of the base is not especially limited, and it is appropriately determined. However, it is generally about 10 to 200 μm.

A method for producing a temperature-responsive sheet having a temperature-responsive layer formed on a base will be described below. The temperature-responsive sheet having a temperature-responsive layer formed on a base can be produced, for example, as follows using the polymer composition.

First, the polymer composition is produced. Next, the polymer composition is applied onto a base to form an application film having a prescribed thickness, and then the application film is dried under a prescribed condition to form a temperature-responsive layer. The application method is not especially limited, and examples thereof include roll coating, screen coating, gravure coating, and the like. The drying is performed at a drying temperature of 50 to 180° C. for example. The polymer composition may be applied onto a separator to form an application film, and then the application film is dried under the above-described drying condition to form a temperature-responsive layer. After that, an adhesive layer is pasted to abase together with the separator. This provides the temperature-responsive sheet having a temperature-responsive layer formed on a base.

The temperature range between a melting start temperature (T₀) and a melting end temperature (T₁) of the crystal of the polymer composition is preferably small. Specifically, the temperature range between the melting start temperature (T₀) and the melting end temperature (T₁) is preferably in a range of ±15° C. from a peak melting temperature (Tm) (measured at a heating rate of 5° C./minute with a differential scanning calorimeter (DSC)), and more preferably ±10° C. therefrom. The polymer composition crystallizes at a temperature lower than Tm, and the side-chain crystalline polymer melts at a temperature higher than Tm. Various properties (properties such as adherability, water repellency, flexibility, transparency, thermal conductivity, electrical conductivity, and releasing of drugs) of the polymer composition change at a temperature higher or lower than the melting temperature Tm. The change of the properties is reversible.

Example of the polymer composition may include those which give a DSC curve of the temperature-responsive sheet produced using the polymer composition such that when measured at a heating rate of 5° C./minute with a differential scanning calorimeter (DSC), the temperature-responsive sheet has the melting start temperature T₀ and the peak melting temperature Tₘ, and the peak melting temperature Tₘ is in a range of T₀ to (T₀+15)° C.

(Adherability)

When the polymer composition is an adhesive composition, example of the cold-release adhesive sheet may include those that are produced using the adhesive composition; that are almost non-adhesive at a temperature lower than the melting start temperature T₀ (especially, a temperature 10° C. or higher than T₀); that are adhesive when they are heated from a temperature lower than T₀ to a temperature higher than Tₘ; and that are non-adhesive when it is cooled from a temperature higher than Tₘ to a temperature lower than T₀. In the present specification, “almost non-adhesive” refers to a state in which the adhesive strength is less than 0.4 N/20 mm (when 180° peeling is performed at 300 mm/minute at a temperature 10° C. or higher than T₀) for example. In the present specification, “adhesive” refers to a state in which the adhesive strength is 0.4 N/20 mm or more (when 180° peeling is performed at 300 mm/min at a temperature equal to or higher than Tₘ) for example. The peak melting temperature Tₘ is preferably within a range of 0 to 110° C., and more preferably within a range of 20 to 90° C.

The polymer composition can be used as an adhesive composition (a temperature-sensitive adhesive) that is peeled when it is cooled. Further, when the adhesive composition is used to produce a sheet-shaped product, the sheet can be used as a cold-release adhesive sheet which is peeled when it is cooled. The adhesive composition (temperature sensitive adhesive) and cold-release adhesive sheet of the present invention can be used as a temporary fixing tape for fixing, a transferring tape for transferring, and a protecting tape for protecting members such as electric and electronic components, semiconductors, ceramic electronic components, and flexible circuit boards in various production processes. When the sheet is used as a temporary fixing tape, examples of a member to be fixed include, but are not especially limited to, a plastic film, a high-functioning carbon-based material, metal, a metal oxide, glass, a silicon wafer, cloth, wood, paper, and the like. When the sheet is used as a transferring tape, examples of a member to be transferred include, but are not especially limited to, a plastic film, a high-functioning carbon based material, metal, a metal oxide, glass, a silicon wafer, cloth, wood, paper, and a substrate formed thereon (for example, thin film transistor, TFT). When the sheet is used as a protecting tape, examples of a member to be protected include, but are not especially limited to, a plastic film, a high-functioning carbon based material, metal, a metal oxide, glass, a silicon wafer, cloth, wood, paper, and a substrate formed thereon (for example, TFT). When the sheet is used as a protecting tape, it can prevent scratching and damage due to chemicals (for example, a developer, an etchant, and a cleaning agent) and water in the step in which those materials are used.

Examples of the plastic film include polyester-based polymer films such as polyethylene terephthalate and polyethylene naphthalate; cellulosic polymer films such as diacetyl cellulose and triacetyl cellulose; acrylic polymer films such as polymethylmethacrylate; styrene-based polymer films such as polystyrene and acrylonitrile-styrene copolymers (an AS resin); polycarbonate-based polymer films; and the like. Further, examples thereof also include polyolefin-based polymer films such as polyethylene, polypropylene, polyolefin having a cyclo- or norbornene-structure, and ethylene-propylene copolymers; vinylchloride-based polymer films; amide-based polymer films such as nylon and aromatic polyamide; imide-based polymer films; sulfone-based polymer films; polyethersulfone-based polymer films; polyetheretherketone-based polymer films; polyphenylenesulfide-based polymer films; vinylalcohol-based polymer films; vinylidene chloride-based polymer films; vinylbutyral-based polymer films; arylate-based polymer films; polyoxymethylene-based polymer films; epoxy-based polymer films; films in which the above-described polymers are blended together; and the like.

Examples of the high-functioning carbon-based material include a carbon nano tube, graphite, grapheme, a grapheme oxide, carbon nano tube to which metal is bonded, and the like.

The adhesive composition (temperature-sensitive adhesive) and the cold-release adhesive sheet are suitable in a production step of a display device (a flexible type, a small-sized type, a thin-layer type) for example. The display system of these display devices is not especially limited, and it may be, for example, a liquid crystal system, a particle moving system, an electrochromic system, and an organic EL system. The use purpose of the display device is not especially limited, and it may be, for example, for TVs, PCs, portable terminals, electronic equipments, and electronic paper. The step of using the present adhesive is not limited in the production process of a display device, and the adhesive can be used, for example, in a TFT forming step, a color filter forming step, a liquid crystal injecting step, an ITO forming step, and the like.

In addition, the adhesive composition (temperature-sensitive adhesive) and the cold-release adhesive sheet are suitably used for a medical treatment, packaging, and the like.

(Flexibility)

The flexibility of the polymer composition preferably improves at a temperature equal to or higher than the melting point as compared to a temperature equal to or lower than the melting point. Specifically, when an initial modulus at a temperature equal to or lower than the melting point and an initial modulus at a temperature equal to or higher than the melting point are compared with each other, the initial modulus at a temperature equal to or higher than the melting point is preferably 1 MPa or more, and more preferably 10 MPa or more lower than the initial modulus at a temperature equal to or lower than the melting point. The larger the difference between the initial modulus at a temperature equal to or lower than the melting point and the initial modulus at a temperature equal to or higher than the melting point, the better it is . However, it is 50 MPa or less or 40 MPa or less for example. When a breaking elongation at a temperature equal to or lower than the melting point and a breaking elongation at a temperature equal to or higher than the melting point are compared with each other, the breaking elongation at a temperature equal to or higher than the melting point is preferably 100% or more larger than the breaking elongation at a temperature equal to or lower than the melting point. The larger the difference between the breaking elongation at a temperature equal to or lower than the melting point and the breaking elongation at a temperature equal to or higher than the melting point, the better it is. However, it is 3,000% or less or 2,000% or less for example. The initial modulus and the breaking elongation can be obtained by the methods described in Examples.

Because even the fluidity of a general polymer composition (one that does not contain a side-chain crystalline component) improves at a high temperature, it becomes flexible. However, the flexibility of the polymer composition of the present invention and that of the temperature-responsive sheet that can be obtained from the polymer composition change remarkably at a temperature higher or lower the melting point.

When the flexibility of the polymer composition and that of the temperature-responsive sheet improves depending on the temperature, the heat-reshaping is possible. Therefore, the polymer composition and the temperature-responsive sheet can be used for molding in a procedure in which a mold is transferred while being heated and then cooled to be released. For example, they can be used in the formation of an uneven fine pattern, casting, molding, as a sealing agent, or the like.

(Transparency)

The transparency of the polymer composition preferably improves at a temperature equal to or higher than the melting point as compared to a temperature equal to or lower than the melting point. Specifically, the haze at a temperature equal to or higher than the melting point is preferably 5% or less, and more preferably 1% or less. When the haze at a temperature equal to or lower than the melting point and the haze at a temperature equal to or higher than the melting point are compared with each other, the haze at a temperature equal to or higher than the melting point preferably improves by 3% or more as a difference than the haze at a temperature equal to or lower than the melting point. The reason why the transparency improves at a temperature equal to or higher than the melting point as compared to that at a temperature equal to or lower than the melting point is surmised that the crystalline portion and the amorphous portion of the polymer composition are in a compatible state at a temperature equal to or higher than the melting point, but the crystalline portion and the amorphous portion of the polymer composition are in a separation state at a temperature equal to or lower than the melting point.

When the transparency of the polymer composition and that of the temperature-responsive sheet change depending on the temperature, they can be used as a film for an electronic equipment, a film for a display device, and a lightproof film. Use thereof as a lightproof film is not especially limited. However, they can be used in buildings such as a window pane, a partition, and a handrail glass; vehicles; and the like.

(Surface Shape)

It is preferable that when the temperature of the temperature-responsive sheet that is produced using the polymer composition is equal to or higher than the melting point, unevenness is formed on its surface, and when it is equal to or lower than the melting point, its surface becomes smooth as compared to the case where the temperature is equal to or higher than the melting point. This is surmised to be because the crystal that melts and expands at a temperature equal to or higher than the melting point projects out to the surface.

(Surface Tension)

When the temperature of the temperature-responsive sheet that is produced using the polymer composition is equal to or higher than the melting point, the surface tension decreases and the contact angle to water increases, and when it is equal to or lower than the melting point, the surface tension increases and the contact angle to water decreases. Specifically, the contact angle to water at a temperature equal to or higher than the melting point is preferably 30 to 130°. When the contact angle to water at a temperature equal to or lower than the melting point and the contact angle to water at a temperature equal to or higher than the melting point are compared with each other, the contact angle to water at a temperature equal to or higher than the melting point preferably improves by 3 to 30°, and more preferably 5 to 20° than the contact angle to water at a temperature equal to or lower than the melting point. The reason why the contact angle to water improves at a temperature equal to or higher than the melting point as compared to that at a temperature equal to or lower than the melting point is surmised that fine unevenness is formed on the surface at a temperature equal to or higher than the melting point as described above. It is also surmised that the surface tension decreases because the convex portion is a side-chain crystalline portion and has high hydrophobicity.

When the surface tension of the polymer composition and that of the temperature-responsive sheet change depending on the temperature, they can be used as a coating agent and a sheet for antifouling, defogging, mold proofing, and anti-biofouling. Examples of use thereof include, but are not especially limited to, coating agents and sheets for a building material (interior and exterior), for an automobile, for an airplane, for a ship, for a solar panel, for -glass, for a lens, for a mirror, for a wet area, and the like.

(Thermal Conductivity)

It is preferable that the thermal conductivity of the temperature-responsive sheet that is produced using the polymer composition improves at a temperature equal to or higher than the melting point. Specifically, the thermal conductivity at a temperature equal to or higher than the melting point is preferably 0.2 W/mK or more. The larger the thermal conductivity at a temperature equal to or higher than the melting point, the better it is. However, it is 1 W/mK or less for example. When the thermal conductivity at a temperature equal to or lower than the melting point and the thermal conductivity at a temperature equal to or higher than the melting point are compared with each other, the thermal conductivity at a temperature equal to or higher than the melting point preferably improves 0.03 W/mL or more than the thermal conductivity at a temperature equal to or lower than the melting point. The larger the improvement of thermal conductivity, the better it is. However, it is 1 W/mK or less for example. The reason why the thermal conductivity improves at a temperature equal to or higher than the melting point as compared to that at a temperature equal to or lower than the melting point is surmised that the fluidity increases at a temperature equal to or higher than the melting point and the adhesion to an adherend occurs. When the thermal conductivity of the polymer composition and that of the temperature-responsive sheet change depending on the temperature, they can be used as a thermal conduction phase change sheet. Use thereof is not especially limited. However, they can be used for releasing heat of electrical and electronic components, telecommunication equipments, illumination equipments, etc.; mounting of semiconductor chips such as CPU, memory, GPU and LED; and the like.

(Electrical Conductivity)

The electrical conductivity of the temperature-responsive sheet that is produced using the polymer composition preferably improves (the volume resistivity thereof preferably decreases) at a temperature equal to or higher than the melting point. Specifically, the volume resistivity at a temperature equal to or higher than the melting point is preferably 1.0×10¹² Ωcm or less. The smaller the volume resistivity at a temperature equal to or higher than the melting point, the better it is. However, it is 1.0×10⁹ Ωcm or more for example. When the volume resistivity at a temperature equal to or lower than the melting point and the volume resistivity at a temperature equal to or higher than the melting point are compared with each other, the volume resistivity at a temperature equal to or higher than the melting point preferably decreases one order of magnitude or more than the volume resistivity at a temperature equal to or lower than the melting point (for example, the volume resistivity at a temperature equal to or higher than the melting point is 1.0×10¹¹ Ωcm or less when the volume resistivity at a temperature equal to or lower than the melting point is 1.0×10¹² Ωcm). The larger the decreased amount, the better it is. However, it is within 3 orders of magnitude for example (for example, the volume resistivity at a temperature equal to or higher than the melting point is 1.0×10⁹ Ωcm or more when the volume resistivity at a temperature equal to or lower than the melting point is 1.0×10¹² Ωcm). The reason why the volume resistivity improves at a temperature equal to or higher than the melting point as compared to that at a temperature equal to or lower than the melting point is surmised that the fluidity increases at a temperature equal to or higher than the melting point and the adhesion to an adherend occurs.

When the electrical conductivity of the polymer composition and that of the temperature-responsive sheet change depending on the temperature, use thereof is not especially limited. However, they can be used in a printed circuit board, a laminated substrate, a quartz resonator, an electronic component, a semiconductor, and the like.

(Releasing Capability of Compound)

When a compound is added to the temperature-responsive sheet that is produced using the polymer composition, the rate of releasing the medicine compound that is internally encapsulated in the temperature-responsive sheet preferably improves at a temperature equal to or higher than the melting point.

The compound that is internally encapsulated in the polymer composition and the temperature-responsive sheet is not especially limited, and it may be an organic compound or may be an inorganic compound. Examples thereof include a drug, a biologically active substance, a catalyst, a curing agent, an initiator, and the like. The polymer composition and the temperature-responsive sheet can be used in a medical application such as a patch, an industrial application, and the like.

(Gas Permeability)

The permeability of gas (such as CO₂, O₂, and H₂O) of the temperature-responsive sheet that is produced using the polymer composition is preferably high at a temperature equal to or higher than the melting point, and the permeability of gas thereof is preferably low at a temperature equal to or lower than the melting point.

Use of the temperature-responsive sheet isnot especially limited. However, it can be used for packaging, as a storage container, for a medical treatment, for a sensor, and for a filter for example.

### EXAMPLES

Preferred Examples of the present invention will be illustratively described in detail below. However, the materials, the blending amounts, etc., described in Examples are not intended for limiting the gist of this invention only to these Examples unless otherwise specified. In addition, “parts” in Examples means “parts by weight.”

### Example 1

<Step of Preparing Side-Chain Crystalline Polymer>

An oil phase liquid was prepared by mixing 100 parts of stearylacrylate and 2 parts of acrylic acid. An aqueous phase liquid was prepared by adding 401 parts of pure water to 1 part of an emulsifier (an anionic nonreactive emulsifier, trade name: HITENOL LA-16, manufactured by DAI-ICHI KOGYO SEIYAKU CO., LTD.) in a solid content. Then, the oil phase liquid and the aqueous phase liquid were mixed, and the mixture was stirred at 6,000 rpm for 1 minute to be forcibly subjected to emulsification using a TK-Homomixer (manufactured by PRIMIX Corporation) so that a monomer pre-emulsion was prepared. Then, the monomer pre-emulsion was treated at a pressure of 100 MPa for 2 pass using a high pressure homogenizer (Nanomizer NM2-L200, manufactured by Yoshida Kikai Co., Ltd.) to obtain a monomer emulsion.

The prepared monomer emulsion was charged in a reactor equipped with a cooling pipe, a nitrogen introducing pipe, a thermometer, and a stirrer. Then, the reactor was substituted with nitrogen, the temperature was raised to 65° C., and 0.7 parts of an initiator (VA-057, manufactured by Wako Pure Chemical Industries, Ltd.) was added. After that, polymerization was carried out for 5 hours to obtain an emulsion A of a side-chain crystalline polymer (glass transition temperature: 41° C.) having a 20% solid content.

<Step of Preparing Amorphous Polymer>

An oil phase liquid was prepared by mixing 96 parts of methylacrylate, 4 parts of diethylacrylamide, and 4 parts of acrylic acid. An aqueous phase liquid was prepared by adding 43 parts of pure water and 3 part of an emulsifier (an anionic nonreactive emulsifier, trade name: HITENOL LA-16, manufactured by DAI-ICHI KOGYO SEIYAKU CO., LTD.) in a solid content. Then, the oil phase liquid and the aqueous phase liquid were mixed, and the mixture was stirred at 2,000 rpm for 2 minutes and at 6,000 rpm for 1 minute to be subjected to emulsification using a TK-Homomixer (manufactured by PRIMIX Corporation) so that a monomer emulsion was prepared.

To a reactor equipped with a cooling pipe, a nitrogen introducing pipe, a thermometer, and a stirrer was added 100 parts of pure water. Then, the reactor was substituted with nitrogen, the temperature was raised to 65° C., and 0.1 parts of an initiator (VA-057, manufactured by Wako Pure Chemical Industries, Ltd.) was added. Then, the monomer emulsion was added dropwise for 3 hours, and then it was aged for 3 hours to obtain an emulsion of an amorphous polymer (glass transition temperature: 14° C.) having a 40% solid content.

<Step of Producing Blend Film>

The prepared emulsion of the side-chain crystalline polymer and the prepared emulsion of the amorphous polymer were mixed so that the amount of the side-chain crystalline polymer was 50 parts in a solid content and the amount of the amorphous polymer was 50 parts in a solid content, and further 0.1 parts of a crosslinking agent (TETRAD/C, manufactured by MITSUBISHI GAS CHEMICAL COMPANY, INC.) was added. The mixture was stirred at 500 rpm for 5 minutes using a TK Robomix (manufactured by PRIMIX Corporation) to obtain a blend emulsion. Then, the obtained blend emulsion was applied on Melinex #12 (a polyester film, manufactured by DuPont) so that the thickness of the coating after drying was 25 μm, and after that, it was dried at 80° C. for 3 minutes in a hot air circulation type oven to obtain a temperature-responsive sheet according to Example 1.

### Example 2

<Step of Preparing Side-Chain Crystalline Polymer>

An emulsion B of a side-chain crystalline polymer (glass transition temperature: 41° C.) was obtained in the same manner as in Example 1 except that stearylacrylate in the step of preparing a side-chain crystalline polymer in Example 1 was changed to cetylacrylate (BLEMMER CA, NOR CORPORATION).

<Step of Producing Blend Film>

A temperature-responsive sheet according to Example 2 was produced in the same manner as in Example 1 except that the emulsion B of a side-chain crystalline polymer was used in place of the emulsion A of a side-chain crystalline polymer.

### Example 3

<Step of Preparing Side-Chain Crystalline Polymer>

An emulsion C of a side-chain crystalline polymer (glass transition temperature: 28° C.) was obtained in the same manner as in Example 1 except that stearylacrylate in the step of preparing a side-chain crystalline polymer in Example 1 was changed to cetylacrylate (BLEMMER CA, NOR CORPORATION).

<Step of Producing Blend Film>

A temperature-responsive sheet according to Example 3 was produced in the same manner as in Example 1 except that the emulsion C of a side-chain crystalline polymer was used in place of the emulsion A of a side-chain crystalline polymer.

### Example 4

<Step of Preparing Side-Chain Crystalline Polymer>

An emulsion D of a side-chain crystalline polymer (glass transition temperature: 44° C.) was obtained in the same manner as in Example 1 except that stearylacrylate in the step of preparing a side-chain crystalline polymer in Example 1 was changed to behenylmethacrylate (BLEMMER VMA-70, NOR CORPORATION).

<Step of Producing Blend Film>

A temperature-responsive sheet according to Example 4 was produced in the same manner as in Example 1 except that the emulsion D of a side-chain crystalline polymer was used in place of the emulsion A of a side-chain crystalline polymer.

### Example 5

<Step of Preparing Side-Chain Crystalline Polymer>

An emulsion E of a side-chain crystalline polymer (glass transition temperature: 21° C.) was obtained in the same manner as in Example 1 except that stearylacrylate in the step of preparing a side-chain crystalline polymer in Example 1 was changed to laurylacrylate (BLEMMER LA, NOR CORPORATION).

<Step of Producing Blend Film>

A temperature-responsive sheet according to Example 5 was produced in the same manner as in Example 1 except that the emulsion E of a side-chain crystalline polymer was used in place of the emulsion A of a side-chain crystalline polymer.

### Example 6

A temperature-responsive sheet according to Example 6 was obtained in the same manner as in Example 1 except that Melinex #12 (a polyester film, manufactured by DuPont) in the step of producing a blend film in Example 1 was changed to a release film (a polyethylene terephthalate base, DIAFOIL MRF38, manufactured by Mitsubishi Plastic, Inc.).

### Comparative Example 1

<Step of Preparing a Water-Dispersible Side-Chain Copolymerization Polymer>

An oil phase liquid was prepared by mixing 50 parts of methylacrylate, 46 parts of stearylacrylate, 4 parts of diethylacrylamide, and 2 parts of acrylic acid. An aqueous phase liquid was prepared by adding 238 parts of pure water to 1 part of an emulsifier (an anionic nonreactive emulsifier, trade name: HITENOL LA-16, manufactured by DAI-ICHI KOGYO SEIYAKU CO., LTD.) in a solid content. Then, the oil phase liquid and the aqueous phase liquid were mixed, and the mixture was stirred at 6,000 rpm for 1 minute to be forcibly subjected to emulsification using a TK-Homomixer (manufactured by PRIMIX Corporation) so that a monomer pre-emulsion was prepared. Then, the monomer pre-emulsion was treated at a pressure of 100 MPa for 2 pass using a high pressure homogenizer (Nanomizer NM2-L200, manufactured by Yoshida Kikai Co., Ltd.) to obtain a monomer emulsion.

The prepared monomer emulsion was charged in a reactor equipped with a cooling pipe, a nitrogen introducing pipe, a thermometer, and a stirrer. Then, the reactor was substituted with nitrogen, the temperature was raised to 65° C., and 0.7 parts of an initiator (VA-057, manufactured by Wako Pure Chemical Industries, Ltd.) was added. After that, polymerization was carried out for 5 hours to obtain an emulsion H of a water-dispersible side-chain crystalline copolymerization polymer having a 30% solid content.

<Step of Preparing Film>

The emulsion H of a water-dispersible side-chain crystalline copolymerization polymer was applied on Melinex #12 (a polyester film, manufactured by DuPont) so that the thickness of the coating after drying was 25 μm, and after that, it was dried at 80° C. for 3 minutes in a hot air circulation type oven to obtain a temperature-responsive sheet according to Comparative Example 1.

### Comparative Example 2

<Step of Preparing a Solvent-Type Side-Chain Crystalline Copolymerization Polymer>

First, 50 parts of methylacrylate, 46 parts of stearylacrylate, 4 parts of diethylacrylamide, and 2 parts of acrylic acid were mixed and put in a reactor equipped with a cooling pipe, a nitrogen introducing pipe, a thermometer, and a stirrer together with 153 parts of ethylacetate and 0.2 parts of initiator AIBN (azobisisobutylonitrile). Then, the reactor was substituted with nitrogen, the temperature was raised to 60° C., and polymerization was carried out for 7 hours to obtain a solution of a solvent-type side-chain crystalline copolymerization polymer having a 40% solid content.

The solution of a solvent-type side-chain crystalline copolymerization polymer was applied on Melinex #12 (a polyester film, manufactured by DuPont) so that the thickness of the coating after drying was 25 μm, and after that, it was dried at 80° C. for 3 minutes in a hot air circulation type oven to obtain a temperature-responsive sheet according to Comparative Example 2.

### Comparative Example 3

<Step of Preparing Film>

The water-dispersible amorphous polymer according to Example 1 was applied on Melinex #12 (a polyester film, manufactured by DuPont) so that the thickness of the coating after drying was 25 μm, and after that, it was dried at 80° C. for 3 minutes in a hot air circulation type oven to obtain a temperature-responsive sheet according to Comparative Example 3.

(Evaluation of Adhesive Strength)

Each of the produced temperature-responsive sheets according to Examples 1 to 5 and Comparative Examples 1 and 2 was cut into a piece of 20 mm wide, and it was kept still under an atmosphere of a temperature at which the adhesive strength was measured for 30 minutes. Then, it was pasted to a stainless plate under an atmosphere of a temperature at which the adhesive strength was measured, and one reciprocation was made with a 2 kg rubber roller to press-bond the measurement piece, and the adhesive strength was measured after 30 minutes. The measurement was performed at 180° peeling and 300 mm/minute in an atmosphere of each measurement temperature using a tensile tester TG-1KN (manufactured by Minebea Co., Ltd.) . The results are shown in Table 1.

In addition, each of the temperature-responsive sheets according to Examples 1 to 4, Comparative Example 1 and Comparative Example 2 which was pasted to a stainless plate in an atmosphere of 60° C. was kept still at room temperature (23° C.) for 30 minutes, and then the adhesive strength was measured at room temperature (23° C.) in the same way as described above. The results are shown in Table 1. The decreasing rate of the adhesive strength at this time is also shown in Table 1. The decreasing rate of the adhesive strength was calculated by the following formula.

(Decreasing Rate of Adhesive Strength)=((Adhesive Strength at 60° C.)−(Adhesive Strength at Room Temperature (23° C.))/(Adhesive Strength at 60° C.)

(Evaluation of an Adhesive Strength Transition Temperature)

Each of the produced temperature-responsive sheets according to Examples 1 to 5 and Comparative Examples 1 and 2 was cut into a piece of 5 mg, a temperature of the melting peak was measured at a condition of a rising temperature rate of 5° C./minute using a differential scanning calorimeter Q2000 (manufactured by TA Instruments Japan Inc.), and it was made to be the adhesive strength transition temperature. The melting start temperature was made to be T₀. The results are shown in Tables 1 and 2.

(Evaluation of Stress-Strain (Evaluation of Flexibility))

Each of the produced temperature-responsive sheets according to Example 6 and Comparative Example 3 was cut into a piece of 10 mm×30 mm, and then the release film was peeled off. A stress-strain test was performed at a distance between chucks of 10 mm and a tensile rate of 50 mm/minute using a tensile tester TG-1KN (manufactured by Minebea Co., Ltd.) to obtain an initial modulus and breaking elongation. The test was performed at room temperature (23° C.) and under an atmosphere of 60° C. The results are shown in Table 2.

(Transparency)

A film in which each of the blended emulsions (the polymer composition) according to Examples 1 to 5 was applied onto a PET (polyethylene terephthalate) film was heated. As a result, it was visibly confirmed that the transparency of any of the films of Examples 1 to 5 was improved by heating.

(Contact Angle to Water)

Each of the temperature-responsive sheets according to Example 6 and Comparative Example 3 was set in a contact angle gauge CA-X (manufactured by Kyowa Interface Science Co., Ltd.). Distilled water was injected in a 1 ml syringe to produce 4 μl of a droplet, and the contact angle to water was measured with a sessile drop method. The measurement value was a value that was measured after 1 minute of the droplet contact. The measurement was performed at room temperature (23° C.) and on a hot plate at 65° C. The results are shown in Table 2.

(Thermal Conductivity)

Each of the polymer compositions according to Example 6 and Comparative Example 3 was poured into a mold of 10 cm×10 cm which was subjected to a peeling treatment, and it was dried at room temperature for a week to produce a film of 2 mm thick. The obtained film was cut into a piece of 20 mm×20 mm, and it was allowed to adhere to a measurement tool with a silicone resin (SCH-20, manufactured by Sunhayato Corp.). The thermal conductivity was measured at 40° C. and 80° C. using a thermal conduction measurement apparatus TCS-200 (manufactured by ESPEC CORP.). The results are shown in Table 2.

(Volume Resistivity)

Each of the temperature-responsive sheets according to Example 6 and Comparative Example 3 was cut into a piece of 100 mm×100 mm, and the release film was peeled off. The temperature-responsive sheet was set in a flat manner on an electrode, and another electrode was set on the top of the temperature-responsive sheet. A value that was obtained after 1 minute when a voltage of 100 V was applied using a high resistance measurement apparatus (Main body: DSM-8104, electrodes: SME-8350, manufactured by HIOKI E.E. CORPORATION) was made to be a measurement value. The measurement was performed at two points at room temperature (23° C.) and 60° C. The results are shown in Table 2.

(Sustained-Release Capability of Drugs)

In the step of producing the blend film in Example 6, the water-dispersible side-chain crystalline polymer and the water-dispersible amorphous polymer were mixed, 0.1 parts of a Dye Fast Green FCF (manufactured by Wako Pure Chemical Industries, Inc.) was then added to 100 parts by weight of a polymer solid content, 0.1 parts of a crosslinking agent (TETRAD/C, manufactured by MITSUBISHI GAS CHEMICAL COMPANY, INC.) was added, and the mixture was stirred at 1,000 rpm for 10 minutes using a TK Robomix (manufactured by PRIMIX Corporation). The mixture was applied onto Lumirror S10 #100 (a polyester film, 100 μm, manufactured by TORAY INDUSTRIES, INC.) so that the thickness after drying was 25 μm. After that, it was dried at 80° C. for 3 minutes in a hot air circulation type oven to obtain the film according to Example 6.

The film that was obtained as described above was cut into a piece of 50 mm×50 mm for every PET substrate. The cut-out film was placed still in 200 ml of distilled water for 10 minutes, and a change of the color of water was observed. The observation was performed at a water temperature of room temperature (23° C.) and 60° C. For the sustained-release capability of drugs, a dye-containing film that does not contain a water-dispersible side-chain crystalline polymer and is composed of only a water-dispersible amorphous polymer was produced as comparison. The case was marked ◯ when the color of the aqueous solution was darker than the film, and the case was marked × when the color of the aqueous solution was equal to or lighter than the film. The results are shown in Table 2.

TABLE 1

| | | Example | Example | Example | Example | Example | Comparative | Comparative |
|---|---|---|---|---|---|---|---|---|
| | | 1 | 2 | 3 | 4 | 5 | Example 1 | Example 2 |
| Adhesive | −5° C. | 0 | 0 | 0 | 0 | 0 | 0 | 0 |
| Strength | 23° C. | 0 | 0 | 0 | 0 | 0.51 | 0 | 0 |
| (N/20 mm) | 30° C. | 0 | 0 | 0.546 | 0 | 0.67 | 0 | 0 |
| | 40° C. | 0 | 0.505 | 0.63 | 0 | 0.72 | 0.438 | 1.175 |
| | 60° C. | 0.4 | 0.813 | 0.688 | 0.66 | 0.61 | 0.638 | 2.55 |
| | 80° C. | 0.18 | 0.75 | 0.7 | 0.51 | 0.4 | 0.3 | 5.75 |
| | 60° C. → 23° C. | 0.015 | 0.02 | 0.027 | 0.01966 | — | 0.048 | 0.025 |

| | | | | | | | |
|---|---|---|---|---|---|---|---|
| Adhesion Transition | 49 | 36 | 23 | 50 | −1 | 35 | 32 |
| Temperature (° C.) | | | | | | | |
| (Temperature (° C.) of | | | | | | | |
| DSC Melting Peak) | | | | | | | |
| Melting Start | 42 | 26 | 12 | 36 | −15 | 8 | 9 |
| Temperature T₀ (° C.) | | | | | | | |
| Decreasing Rate (%) | 96.3 | 97.5 | 96.1 | 97 | — | 92.5 | 99 |
| of Adhesive Strength | | | | | | | |

TABLE 2

| | | | | Comparative |
|---|---|---|---|---|
| | | | Example 6 | Example 3 |
| Adhesion Transition Temperature (° C.) | | | 49 | — |
| (Temperature (° C.) of DSC Melting Peak) | | | | |
| Evaluation of | Initial Modulus | 23° C. | 37.7 | 3.22 |
| Strain-Stress | (MPa) | 60° C. | 0.336 | 0.78 |
| | Breaking Elongation | 23° C. | 31 | 523 |
| | (%) | 60° C. | 1150 | 409 |

| | | | |
|---|---|---|---|
| Contact Angle to Water (°) | 23° C. | 96 | 41 |
| | 65° C. | 105 | 31.3 |
| Thermal Conductivity (W/mK) | 40° C. | 0.175 | 0.202 |
| | 80° C. | 0.247 | 0.19 |
| Volume Resistivity (Ωcm) | 23° C. | 1.9 × 10¹² | 8.3 × 10¹² |
| | 60° C. | 7.1 × 10¹¹ | 2.6 × 10¹² |
| Releasing Capability of Drugs | 23° C. | X | — |
| | 60° C. | ◯ | — |

(Result)

In Comparative Example 1 in which the side-chain crystalline polymer and the amorphous polymer were copolymerized and Comparative Example 2 in which the side-chain crystalline polymer and the amorphous polymer were dissolved in a solvent, the temperature of the melting peak was low, and the temperature difference (Tₘ−T₀) from the melting start temperature T₀ was large of 20° C. or higher. Because of that, a result was lead that the temperature sensitivity deteriorated.

1. A polymer composition comprising a water-dispersible side-chain crystalline polymer and a water-dispersible amorphous polymer.

2. The polymer composition according to claim 1, wherein the water-dispersible amorphous polymer has a glass transition temperature equal to or lower than the glass transition temperature of the water-dispersible side-chain crystalline polymer.

3. An adhesive composition comprising the polymer composition according to claim 1 or 2.

4. A temperature-responsive sheet, which is produced using the polymer composition according to claim 1 or 2.

5. A cold-release adhesive sheet, which is produced using the adhesive composition according to claim 3.
